(19) United States
(12) Patent Application Publication
(10) Pub. No.: US 2015/0180345 A1
(43) Pub. Date: Jun. 25, 2015

(54) MULTI-MODE CONTROL OF A FULL BRIDGE RESONANT CONVERTER

(71) Applicant: Damien FROST, Toronto (CA)

(72) Inventor: Damien Frost, Toronto (CA)

(21) Appl. No.: 14/415,680

(22) PCT Filed: Oct. 4, 2012
(86) PCT No.: PCT/CA2012/000922

§ 371 Date: Jan. 19, 2015

Related U.S. Application Data
(60) Provisional application No. 61/673,370, filed on Jul. 19, 2012.

(51) Int. Cl. H02M 3/335

(52) U.S. Cl. CPC H02M 3/33507

(57) ABSTRACT

Systems and methods for operating a full bridge resonant converter network in various modes of operation, at least one mode may include operating in a half bridge converter mode of operation. The resonant converter network includes a switching network, a resonant network, an output rectifier network, and a controller. The controller is configured to: receive feedback input signals and provide output signals to operate the converter in its most efficient operating mode. In the half bridge operating mode, the controller will provide output signals to one set of switches based on the received feedback input signals and provide output signals to another set of switches to maintain an active signal state of a first switch and to maintain an inactive signal state of a second switch.

### FIELD

At least some example embodiments relate to the field of power converters, for example switching resonant converters.

### BACKGROUND

Some conventional control systems for switch mode power supplies (SMPS) involves measuring output voltages and/or currents, comparing those measured values to the desired ones, and adjusting the control signals as required to regulate the resultant output. Often, such methods control the control signals by a single control algorithm, or function. For example, in some such systems that may use a voltage controller, the output voltage is compared to a reference value to create an error signal. This error signal is processed through a single transfer function, or compensator which serves as the single control algorithm. The output of this function yields a signal to control the switches.

A full bridge switching configuration of a resonant converter typically includes four switches configured in an H-bridge. For many conventional resonant converters, a single control algorithm is used which varies the switching frequency of the switching network based on feedback from the output voltage measurement. However, such systems may have limited operational flexibility, and may not provide optimal power efficiency at some power levels.

Some conventional systems can operate the full bridge configuration in a half bridge mode (e.g. driving using only two of the switches). In order to do so, such systems may require two filter capacitors, each in parallel with one switch on the same switching leg of the H-bridge. These capacitors are used to prevent a DC current from accumulating in the resonant network. However, such systems can require additional capacitor components in the switching.

Another difficulty which can arise is the action of transitioning between any two modes of operation. During one of these transitions, a disturbance may arise at the regulated output due to this abrupt mode change. Smoother signaling may be desired.

Other difficulties with existing systems may be appreciated in view of the description below.

### SUMMARY

According to one aspect, there can be provided systems and methods for operating a full bridge resonant converter network in various modes of operation, wherein at least one mode includes operating in a half bridge converter mode of operation. The resonant converter network includes a switching network, a resonant network, an output rectifier network, and a controller. The switching network includes a first set of switches and a second set of switches in parallel with the first set of switches, each set of switches including a first switch and a second switch. A controller is configured to: receive feedback input signals and provide output signals to the switching network. In the half bridge operating mode, the controller will provide output signals to one set of switches based on the received feedback input signals, and provide output signals to the other set of switches to maintain an active signal state of the first switch and to maintain an inactive signal state of the second switch.

According to another aspect, there can be provided a controller for controlling a resonant converter network, the resonant converter network including a switching network, the switching network including a first set of switches and a second set of switches in parallel with the first set of switches, a resonant network, and an output rectifier network. The controller includes components configured to: receive feedback input signals, the input signals including load-based input signals and environmental measurements, determine a most efficient operating mode based on at least the environmental measurements, and provide output signals to operate the first set of switches and the second set of switches based on the received load-based input signals in the determined most efficient operating mode.

In example embodiments, the operating modes include at least one of: full bridge converter operating as a full bridge converter mode, full bridge converter operating as a half bridge converter mode, shutting down a phase, and a resonant current interrupting mode. The resonant current interrupting mode further includes operation of a voltage controllable switch within the resonant network.

According to another aspect, there can be provided a method for controlling a resonant converter network, the resonant converter network including a switching network, the switching network including a first set of switches and a second set of switches in parallel with the first set of switches, each set of switches including a first switch and a second switch. The resonant converter network further includes a resonant network and an output rectifier network. The method includes: receiving feedback input signals, providing output signals to operate one set of switches based on the received feedback input signals, and providing output signals to the other set of switches to maintain an active signal state of the first switch and to maintain an inactive signal state of the second switch.

According to another aspect, there can be provided a non-transitory computer readable medium having instructions stored thereon executable by a controller for controlling a resonant converter network, the resonant converter network including a switching network, the switching network including a first set of switches and a second set of switches in parallel with the first set of switches, each set of switches including a first switch and a second switch. The resonant converter network further includes a resonant network and an output rectifier network. The instructions include: instructions for receiving feedback input signals, instructions for providing output signals to operate one set of switches based on the received feedback input signals, and instructions for providing output signals to the other set of switches to maintain an active signal state of the first switch and to maintain an inactive signal state of the second switch.

Other advantages, features and characteristics of the systems and methods, will become more apparent upon consideration of the following detailed description and the appended claims.

### BRIEF DESCRIPTION OF THE FIGURES

Embodiments will now be described, by way of example only, with reference to the attached Figures, wherein:

FIG. 1 illustrates a diagrammatic view of a resonant converter system to which example embodiments may be applied;

FIG. 2 illustrates an example embodiment of a circuit diagram illustrating a resonant converter network for use in the system of FIG. 1, in accordance with an example embodiment;

FIG. 3 illustrates an example voltage signaling diagram for transitioning from a half bridge converter mode to a full bridge converter mode for the network of FIG. 2;

FIG. 4 illustrates an example voltage signaling diagram for transitioning from a full bridge converter mode to a half bridge converter mode for the network of FIG. 2;

FIG. 5 illustrates an example graph of hysteretic control for switching between the half bridge and full bridge converter modes for the system of FIG. 1;

FIG. 6 illustrates an example graph of efficiency versus power for various modes for the system of FIG. 1 as compared to a system which only uses one mode of operation;

FIG. 7 illustrates an example table for controlling modes of the system of FIG. 1, in accordance with an example embodiment;

FIG. 8 illustrates an example embodiment of a circuit diagram illustrating a multi-phase resonant converter network, for use in the system of FIG. 1, in accordance with another example embodiment;

FIG. 9 illustrates an example voltage signaling diagram for the network of FIG. 8; and

FIG. 10 illustrates an example flow diagram of a method for controlling a resonant converter system, in accordance with an example embodiment.

### DETAILED DESCRIPTION OF EXEMPLARY EMBODIMENTS

Some exemplary embodiments generally involve operating a full bridge resonant converter network in various modes of operation, wherein at least one mode may include operating the switching network in a half bridge converter mode of operation. One mode may be provided which may include removing a phase of the converter network by shutting down all of the switches for that phase of the converter network.

With the advancements in digital controllers, more advanced control algorithms may be performed on a resonant converter network. In some example embodiments, a controller is used to operate the resonant converter network in different modes, implementing different control algorithms, or functions, depending on the detected operating state of the converter. This may be performed to improve the overall efficiency of the converter.

Some example embodiments relate to a controller that regulates the particular mode of operation, or control algorithm, of the resonant converter network. For example, in one embodiment the resonant converter network is able to operate in one of a various number of operating modes. In each mode of operation, a different control algorithm or function is used to maximize the efficiency of the converter. In addition to these controllers, another controller exists to manage which control algorithm or function should be executed in order to maximize the efficiency.

Reference is now made to FIG. 1, which shows a resonant converter system 100 to which example embodiments may be applied. For ease of reference, in some example embodiments the system 100 will be described as a DC-DC resonant converter system, although other circuits or networks may be implemented. The system includes a resonant converter network 102 which is controlled by a controller 104. The resonant converter network 102 receives power from a power source 106, such as DC voltage represented as Vin (+/−). A load 108 is driven by the resonant converter network 102, typically to provide a controlled or specified voltage output or DC voltage output.

In some example embodiments, the controller 104 is configured to receive feedback input signals 110, and based on the received signals 110, provide output signals 112 (e.g. switching commands) to operate the switching network 114, and to operate a particular mode of the resonant converter network 102. This provides the resultant drive voltage to the load 108. The controller 104 may further be configured to operate one or more phases 120 of the resonant converter network 102, shown as Phase 1, . . . , Phase n, described in greater detail herein.

Referring still to FIG. 1, the resonant converter network 102 includes at least a DC-AC switching network 114, a resonant network 116 (e.g. resonant tank) for receiving the AC signal from the switching network 114, and an AC-DC output rectifier network 118 for rectifying the signal from the resonant network 116. This provides at least switching resonant conversion for implementing various operational modes of the system 100. In one example mode, for example, load voltage may be controlled based on the controlled switching frequency of the switching network 114, as would be understood in the art. It is recognized herein that some power efficiencies may be provided depending on the particular selected operational mode of the system 100.

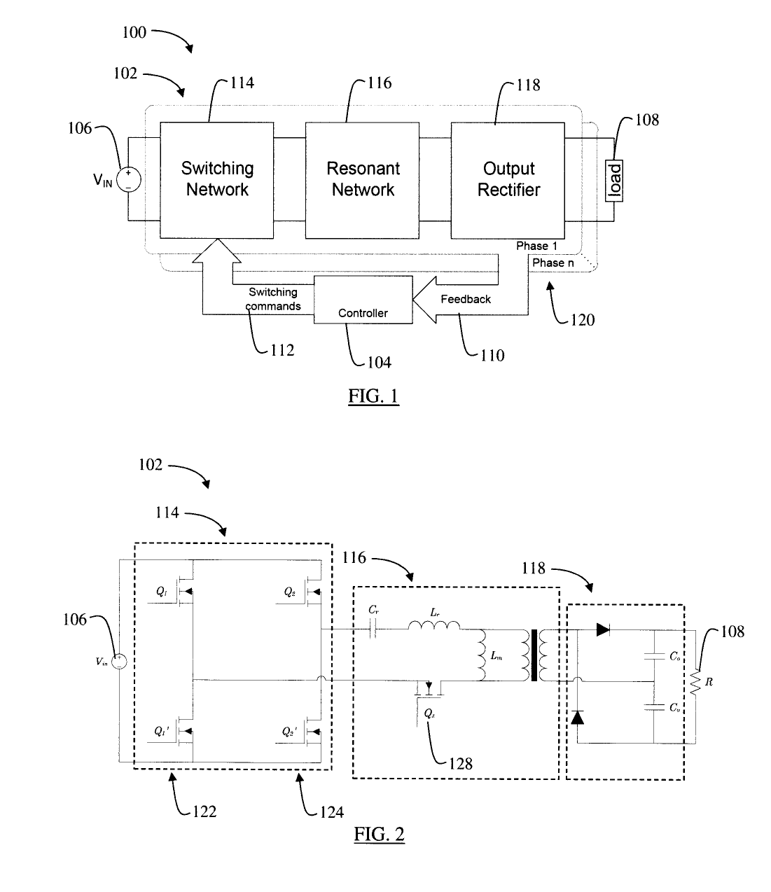

Reference is now made to FIG. 2, which illustrates an example embodiment of the resonant converter network 102 in greater detail. The switching network 114 includes first set or pair of switches 122 (Q1, Q1′) and second set or pair of switches 124 (Q2, Q2′) in parallel in an H-bridge configuration. Such a system having two sets of switches 122, 124 may be referred to as a full bridge converter. In the example embodiment shown, Q1 and Q1′ represent respective inverted signals, and Q2 and Q2′ represent respective inverted signals. In the example embodiment shown, the switches are metal-oxide-semiconductor field-effect transistor (MOSFET), although other suitable switches may be used.

Referring still to FIG. 2, the resonant network 116 may include a LLC circuit. The resonant network 116 may include a transformer 126, or in alternate embodiments be transformerless. One end of the resonant network 116 is center-tapped to the first set of switches 122 and the other end of the resonant network 116 is center-tapped to the second set of switches 124. In some example embodiments, the resonant network 116 may also include an interrupt switch 128 (Qx) which is operable to interrupt current in the resonant network 116 by maintaining a high voltage across the interrupt switch 128. The interrupt switch 128 may be in series with the LLC circuit. In the example embodiment shown, the interrupt switch 128 is a MOSFET, although other suitable switches may be used.

As shown in FIG. 2, the example output rectifier network 118 may include, for example, two output diodes and two output filtering capacitors configured for rectifying the received signal for driving the load 108.

Various modes may be implemented by the controller 104 by controlling at least one of the switching network 114 and the interrupt switch 128. In example embodiments, the modes include at least one of: full bridge converter operating as a full bridge converter mode, full bridge converter operating as a half bridge converter mode, and a resonant current interrupting mode. In some example embodiments, the efficiency of the resonant converter network 102 may be improved by using different control modes at different input power levels.

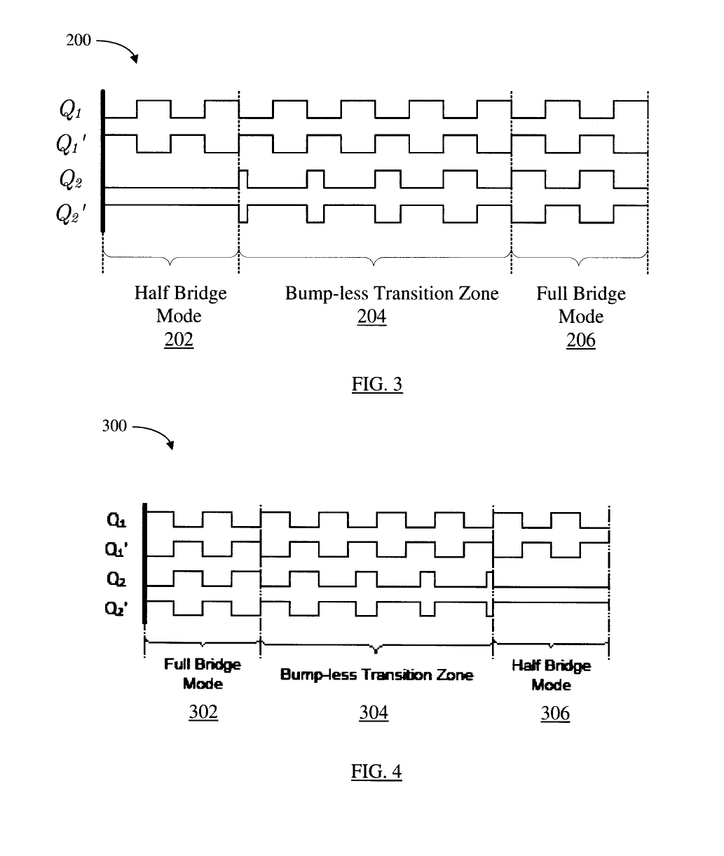

The full bridge converter mode and half bridge converter mode are best illustrated in FIG. 3, which illustrates an example voltage signaling diagram 200. The voltage signaling diagram 200 illustrates the half bridge converter mode 202, a transition zone 204, and the full bridge converter mode 206.

In the half bridge converter mode 202, the controller 104 is configured to provide output switching signals 112 to operate only the first set of switches 122 based on the received feedback input signals 110. For example, referring to the first set of switches 122, wherein Q1 is controlled to a have a controlled duty cycle, frequency, phase shift, or pulse width, etc., while Q1′ has inverted control signals with respect to Q1. The controller 104 is also configured to provide output signals to maintain the state of the second set of switches 124. For example, referring to the second set of switches 124, Q2 is maintained at low inactive signal state and Q2′ is maintained at high active signal state in the half bridge converter mode. At this stage, Q2′ therefore shorts the capacitor Cr of the resonant network 116 to the power source 106 (or ground, as appropriate). This results in shutting down the switching leg provided by the second set of switches 124. It would also be appreciated that for such signaling Q2 is always inverted from Q2′. It would also be appreciated that filter capacitors would not be required in the switching network 114 in some example embodiments because the resonant capacitor, Cr in the resonant network 106, will block any DC current in the resonant network 106.

In the full bridge converter mode 206, the controller 104 is configured to provide output switching signals to provide switching control to both the first set of switches 122 and the second set of switches 124 based on the received feedback input signals. For example, these switches may be controlled to have a controlled duty cycle, frequency, phase shift, or pulse width, etc.

The switching control of one or both sets of switches 122, 124 can be used to control the resultant voltage to the load 108, typically calculated by the controller 104 based on the received feedback input signals 110. In an example mode, the frequency of the switches may be controlled to be increased or decreased, as understood in the art. In another example mode, the pulse width of the switches may be controlled to be increased or decreased. In another example mode, phase shifting of the switches may be controlled to be increased or decreased between each set of switches 122, 124. In this mode, instead of changing the switching frequency of the gating signals, the controller changes the phase between each set of switches 122, 124. This can result in Q1 and Q2 being on at the same time, as well as Q1′ and Q2′. This can result in adding a ‘zero’ state, that is, the resonant network 116 experiences an input voltage differential of 0V when both Q1 and Q2 are on. Each of these types of controls or modes may be performed by the controller 104 in the half bridge converter mode and/or the full bridge converter mode, with the exception of phase shift control which can only be implemented in full bridge converter mode. Combinations and sub-combinations of these modes may also be performed, as appropriate.

The resonant current interrupting mode, typically controlled through at least the interrupt switch 128, will now be described in further detail. At least some example implementations of half-bridge or full-bridge resonant converter circuits having an interrupt switch are described in U.S. patent application Ser. No. 13/469,060 entitled DC-DC CONVERTER CIRCUIT USING LLC CIRCUIT IN THE REGION OF VOLTAGE GAIN ABOVE UNITY, filed May 10, 2012, having a common co-inventor as the present application, the contents of which are hereby incorporated by reference. In addition to those examples described, it is recognized herein that operation of the interrupt switch 128 can further be performed using the full bridge converter of the resonant converter network 102 operating as a half bridge converter mode.

In some example embodiments, as recognized herein, the efficiency of the resonant converter network 102 may be controlled by using different control modes in dependence of a detected control variable from one or more of the feedback input signals 110. In some example embodiments, two or more feedback input signals 110 may be used. The feedback input signals 110 to the controller 104 can include one or more of, for example, load properties such as voltage measurements, current measurements, power measurements, and environmental measurements such as temperature, humidity, wind speed, time, etc. The same or different feedback input signals 110 may be used to operate the resonant converter network 102 within the particular mode of operation, for example to adjust the pulse frequency, etc.

The controller 104 determines which control mode to operate in, based on the feedback input signals 110. The points at which to switch modes can be hard coded for the controller 104. Alternatively, the controller 104 can use algorithms to correlate its most efficient operating mode with its feedback signals for all operating points. In this way, the resonant converter network 102 can operate in its most efficient operating mode at all times throughout its service life.

For example, an input power level threshold may be used as the detected control variable to operate the resonant converter network 102 in a given mode. In one example, for power levels greater than on or about 30%, it may be considered optimal to operate the converter in full bridge converter operating with e.g. frequency control. In this mode, the interrupt switch 128 (Qx) is constantly “on”, thus appearing as a small resistor in the circuit. For power levels less than on or about 30%, operating the resonant converter network 102 in the interrupt mode may be suitable, by controlling the interrupt switch 128 at suitable times.

In another example, for power levels less than on or about 30%, operating the converter as a half bridge converter may be considered optimal, by controlling only the first set of switches 122 and maintaining the state of the second set of switches 124. In this mode, the interrupt switch 128 (Qx) is constantly “on”, thus appearing as a small resistor in the circuit.

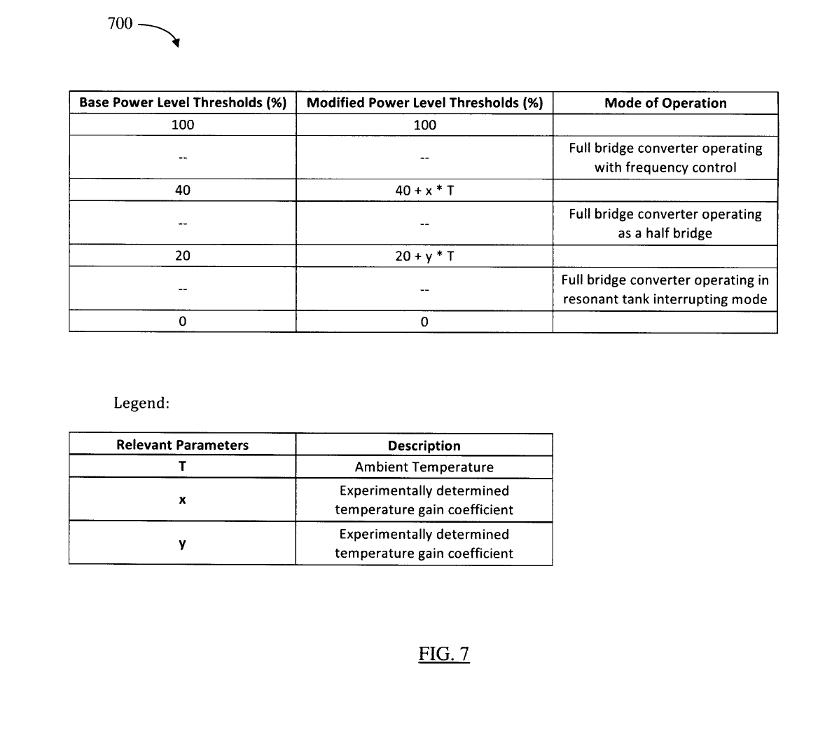

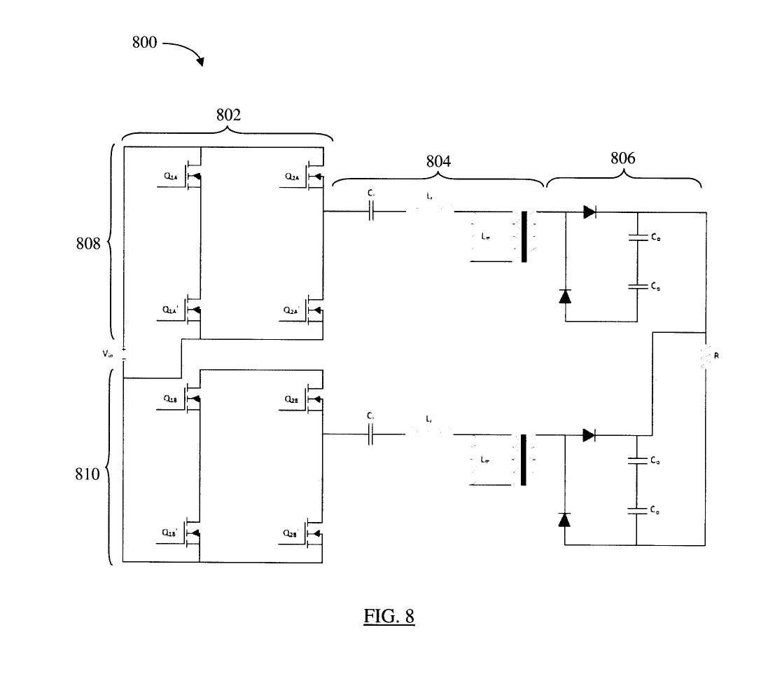

Reference is now made to FIG. 7, which shows an example table for controlling various modes of the system of FIG. 1, based on input feedback signals 110, in accordance with an example embodiment. It would be appreciated that the actual values may vary depending on the particular application, in accordance with other example embodiments. In this example, the input power is the main determining factor of which mode the converter should operate in. However, voltage or current could also be used, current being the most appropriate choice, for most applications.

In the example of FIG. 7, the specified power threshold may be for a fixed base power level threshold percentage, such as 0-20% for operating in interrupt mode, 20% to 40% for half bridge converter mode, and 40%-100% for full bridge converter mode, as shown.

In another example shown in FIG. 7, the power thresholds may be calculated by modifying the base power threshold based on an environmental input, such as a detected ambient temperature. However, the threshold may be varied or modified by other environmental factors such as humidity or other temperature sensors. In FIG. 7, the following legend is used: T is Ambient Temperature, x is an experimentally determined temperature gain coefficient; and y is an experimentally determined temperature gain coefficient. As shown in FIG. 7, the specified power threshold may be 0 and 20+y*T percent for operating in interrupt mode, between 20+y*T percent and 40+x*T percent for operating in half bridge converter mode, and between 40+x*T percent and 100 percent for operating in full bridge converter mode.

Reference is again made to FIG. 3, which illustrates the transition zone 204 from the half bridge converter mode 202 to the full bridge converter mode 206. The controller 104 is capable of a bump-less transition (or reduced bump transition) between operating modes of the converter. As shown in FIG. 3, referring to the second set of switches 124, the duty cycle of upper switch of the inactive half bridge, Q2, is gradually increased from 0% to 50%, completing the transition to full bridge converter mode. As shown in FIG. 3, in the full bridge converter mode 206 the duty cycle may include a full bridge pulse width (50% duty cycle) at a controlled frequency. In the transition zone 204, the pulse width of Q2 is gradually increased from zero to the full bridge pulse width (50% duty cycle) for the full bridge converter mode 206. In the transition zone 204, the duty cycle of Q2′ is gradually decreased to the full bridge pulse width (50% duty cycle). During the transition zone 204, the voltage controller, or other appropriate controller, is constantly regulating its output signal to maintain a constant output. Note that, in this case, the interrupt switch 128 (Qx) is constantly “on”. Further, note that the transition time may be reduced or increased depending on the application. Further, in this example the duty cycle is linearly incremented from 0% to 50%, however it may be incremented in a non-linear fashion, depending on the application.

Switching to half bridge control from full bridge control can be advantageous in low power situations. When there is a large load, the resonant converter network 102 operates in full bridge control mode driving the resonant network 116 with +Vin and −Vin. When the load is reduced, less power is required to be transferred, and thus the controller 104 switches to half bridge control mode. In this mode the resonant network 116 is driven with +Vin and 0V or −Vin and 0V, effectively halving the input power. In addition, the switching losses will be halved since only half the switches will be operating.

Reference is now made to FIG. 4, which illustrates another example voltage signaling diagram 300 for the system 100. The voltage signaling diagram 300 illustrates the full bridge converter mode 302, a transition zone 304, and the half bridge converter mode 306. The controller 104 is capable of a bump-less transition (or reduced bump transition) between these operating modes of the converter. As shown in FIG. 4, referring to the second set of switches 124, the duty cycle of upper switch of the half bridge, Q2, is gradually decreased from 50% to 0%, completing the transition to half bridge converter mode. As shown in FIG. 4, in the transition zone 304, the full bridge pulse width of Q2 is gradually decreased from the present pulse width to zero. The duty cycle of Q2′ is gradually increased to 100%, to a maintained signal in the active state). In the half bridge converter mode 306, Q2 is maintained as inactive while Q2′ is maintained as active. Note that, in this case, the interrupt switch 128 (Qx) is constantly “on”.

Referring again to FIGS. 3 and 4, the second set of switches 124 may not necessarily be the switches which are shut off in the half-bridge converter mode. In some example embodiments, the first set of switches 122 may be selected to be shut off. In some example embodiments, the controller 104 may be configured to selectively shut off a different half bridge of the full bridge each time it enters the half-bridge converter mode to distribute the wear and heat amongst the switching components. For example, the load may be distributed so that each set of switches 122, 124 drives the half bridge approximately 50% of the time. For example, the amount of load can be tracked and stored by the controller 104.

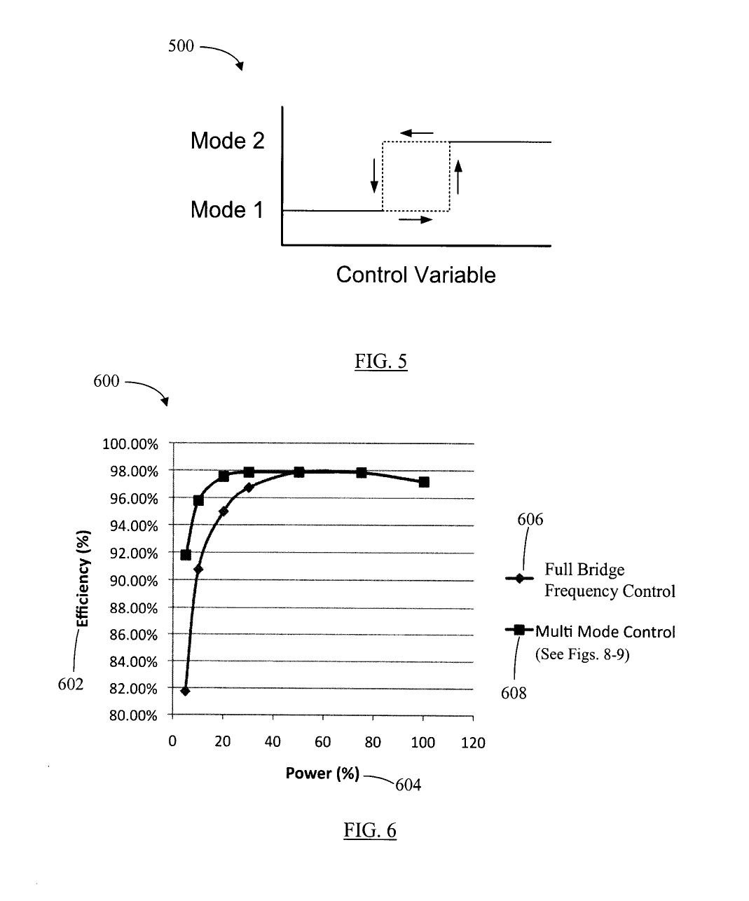

Reference is now made to FIG. 5, which illustrates an example graph 500 of hysteretic control for switching between the half bridge and full bridge converter modes for the system 100 of FIG. 1. Hysteretic control may be used to avoid instabilities occurring during mode transition. A threshold of a control variable, such as power level, may be varied or determined in dependence of the last performed transition. To avoid rapidly transitioning between two states, the controller 104 can implement the hysteric control scheme to “lock” the control state into a new mode during a transient.

Reference is now made to FIG. 8, which illustrates an example embodiment of a circuit diagram illustrating a multi-phase resonant converter network 800, for use in the system of FIG. 1, in accordance with another example embodiment. The resonant converter network 800 may be controlled to add or shut down one or more phases. For example, less phases may be used during low power operation.

Referring still to FIG. 8, the resonant converter network 800 includes at least a DC-AC switching network 802, a resonant network 804 (e.g. resonant tank), and an AC-DC output rectifier network 806. The resonant network 800 includes two full-bridge resonant LLC converters connected in parallel, shown as first converter 808 and second converter 810. Each converter 808, 810 may be referred to as a phase of the multi-phase configuration. Each of the converters include four transistors that make up the H-bridge, a resonant network, two output diodes, and two output filtering capacitors. As the input power is reduced, phases 808, 810 can be turned off to increase the overall efficiency of the converter. An interrupt switch (not shown) may be included in one or both converters 808, 810.

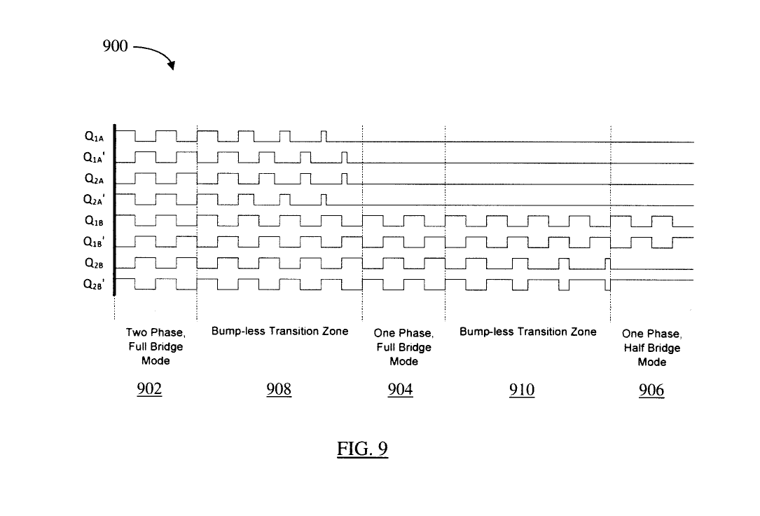

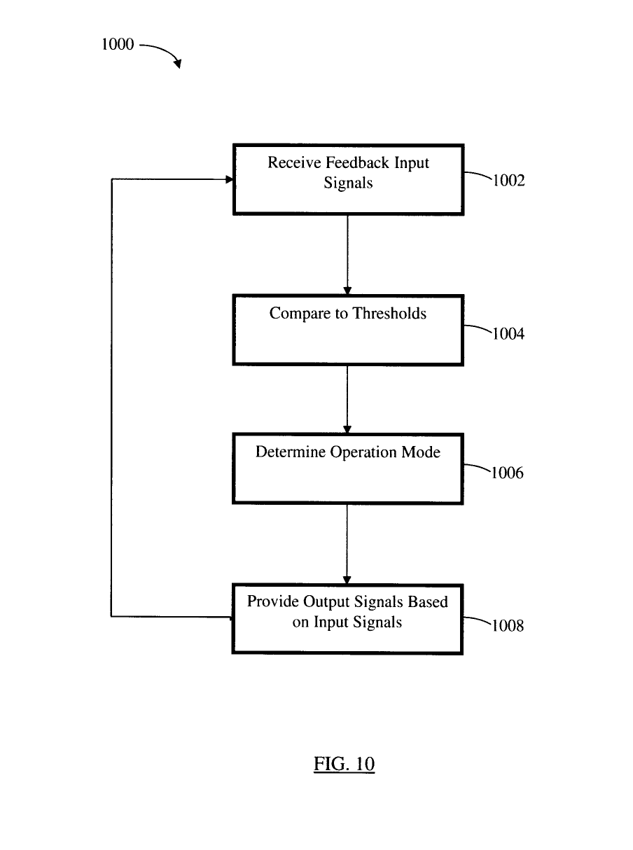

Reference is now made to FIG. 9, which illustrates an example voltage signaling diagram 900 for the network 800. The diagram 900 shows the gating pattern used to transition from two phases 808, 810 operating in full bridge converter mode 902 to one phase 810 operating in one phase full bridge converter mode 904 to the one phase 810 operating in the one phase half bridge converter mode 906. The diagram 900 also shows one example implementation of a bump less mode transition, shown as first transition zone 908 and second transition zone 910, operating in a similar manner as described above with respect to FIG. 4. Referring again to FIG. 8, additional phases may be added, as appropriate, each phase being a controllable half-bridge or full-bridge resonant LLC converter connected in parallel, for example up to n phases. A phase may be added or shut off, depending on the detected power levels.

FIG. 6 illustrates an example graph 600 of efficiency 602 versus power 604 for multi-mode control 608 as per the system shown in FIGS. 8 and 9, as compared to a conventional resonant controller using only full bridge frequency control 606. As shown in FIG. 6, the controller 104 is able to operate in different operating modes creating the multi-mode control efficiency plot 608. In this example, the converter was implemented with two phases. The multi-mode control implemented by the controller 104 is able to shut down one phase of the resonant converter network 802 when the input power is low. When a phase is shut down, this allows the remaining phase to operate at a more efficient operating point. As the power 604 further decreases, the operating phase will further operate in half bridge mode to further increase the efficiency of the converter network 802.

A specified power level threshold may, for example, be on or about 30%. When the power is above 30%, both phases 808, 810 of the resonant converter network 802 are operated in the full bridge converter mode. When the power is below 30%, the resonant converter network 802 is operated in single phase mode, where all of the switches for one phase 808 are shut down. At another specified power level threshold, which may be on or about 10% for example, the resonant converter network will operate one phase 810 of the switching network 802 in half bridge mode when the power is below 10%.

As shown in FIG. 6, the efficiency of the conventional control 606 versus multi-mode control 608 is the same for high power when both converters 808, 810 (FIG. 8) are operating at higher power levels. At a specified power level threshold, 30% in the case shown in FIG. 6, one phase is shut off. At another specified power level threshold, 10% in the case shown in FIG. 6, the remaining phase operates in half bridge converter mode. As a consequence, in each mode of operation the converter is moved to an operating point with higher efficiency. The result is improved efficiency at low power as shown in FIG. 6.

Referring again to FIGS. 8 and 9, the first phase 808 may not necessarily be the switches which are shut off. In some example embodiments, the second phase 810 may be selected to be shut off. In some example embodiments, the controller 104 may be configured to turn off a different phase 808, 810 of the two-phase system each time it enters a low power state to distribute the wear and heat amongst components. For example, the load may be distributed so that each phase 808, 810 drives the system 50% of the time, when removing a phase for lower power operation. Further, within each phase 808, 810, each set of switches can be selected to drive the respective half-bridge mode 50% of the time within the phase.

FIG. 10 illustrates an example flow diagram of a method 1000 implemented by the controller 104 for controlling a resonant converter system, in accordance with an example embodiment. The method 1000 may be configured as a loop, as shown. Other example configurations such as state-based processing may also be implemented. At event 1002, the controller 104 receives feedback input signals. At event 1004, the controller 104 determines a threshold of a control variable of the received feedback input signals, an example control variable being the detected power. The threshold may be varied based on another received feedback input signal such as the temperature, for example. The threshold may be determined or varied based on the transitioning between modes, using hysteretic control. In some example embodiments, the threshold is a fixed or hard-coded value. The control variable is then compared to the determined threshold. Note that, multiple thresholds may be used depending on the number of modes.

At event 1006, the controller 104 determines which mode to operate the resonant converter system, by determining whether the control variable (e.g. power) is above or below the determined threshold. For example, the resonant converter system may be operated in full-bridge converter mode if the control variable is above the determined threshold, or operate in half-bridge converter mode if the control variable below the determined threshold. At event 1008, the controller 104 provides output signals (e.g. switching commands or holding state commands) to operate the switching network based on the received feedback input signals (e.g. load voltage), for example to control the frequency of switching, the pulse width, the duty cycle, etc. The method 1000 may be repeated, as appropriate.

Although example embodiments of the system 100 have been primarily described as dc to dc, it would be appreciated that other example embodiments may be applied to (or form part of) dc to ac, ac to dc, or ac to ac power conversion systems.

Some example embodiments of the described controller 104 include a processor, microprocessor, microcontroller, a programmable logic circuit (PLC), an Application-Specific Integrated Circuit (ASIC) controller, and/or a central processing unit (CPU), related components, and the like. The controller 104 can include components to execute instructions stored on a computer-readable medium, for performing the described processes and methods. The controller 104 can operate as separate controllers or logical entities, or can be the combined operation or function of separate controllers or logical entities.

While some of the embodiments are described in terms of methods, a person of ordinary skill in the art will understand that present embodiments are also directed to various apparatus including components for performing at least some of the aspects and features of the described methods, be it by way of hardware components, software or any combination of the two, or in any other manner. Moreover, an article of manufacture for use with the apparatus, such as a pre-recorded storage device or other similar non-transitory computer readable medium including program instructions recorded thereon, or a computer data signal carrying computer readable program instructions may direct an apparatus to facilitate the practice of the described methods. It is understood that such apparatus, articles of manufacture, and computer data signals also come within the scope of the present embodiments.

While some of the above examples have been described as occurring in a particular order, it will be appreciated to persons skilled in the art that some of the steps or processes may be performed in a different order provided that the result of the changed order of any given step will not prevent or impair the occurrence of subsequent steps. Furthermore, some of the steps described above may be removed or combined in other embodiments, and some of the steps described above may be separated into a number of sub-steps in other embodiments. Even further, some or all of the steps of the method may be repeated, as necessary. Elements described as methods or steps similarly apply to systems or subcomponents, and vice-versa.

The term “computer readable medium” as used herein includes any medium which can store instructions, program steps, or the like, for use by or execution by a computer or other computing device including, but not limited to: magnetic media, such as a diskette, a disk drive, a magnetic drum, a magneto-optical disk, a magnetic tape, a magnetic core memory, or the like; electronic storage, such as a random access memory (RAM) of any type including static RAM, dynamic RAM, synchronous dynamic RAM (SDRAM), a read-only memory (ROM), a programmable-read-only memory of any type including PROM, EPROM, EEPROM, FLASH, EAROM, a so-called “solid state disk”, other electronic storage of any type including a charge-coupled device (CCD), or magnetic bubble memory, a portable electronic data-carrying card of any type including COMPACT FLASH, SECURE DIGITAL (SD-CARD), MEMORY STICK, and the like; and optical media such as a Compact Disc (CD), Digital Versatile Disc (DVD) or BLU-RAY Disc.

Variations may be made to some example embodiments, which may include combinations and sub-combinations of any of the above. The various embodiments presented above are merely examples and are in no way meant to limit the scope of this disclosure. Variations of the innovations described herein will be apparent to persons of ordinary skill in the art having the benefit of the present disclosure, such variations being within the intended scope of the present disclosure. In particular, features from one or more of the above-described embodiments may be selected to create alternative embodiments comprised of a sub-combination of features which may not be explicitly described above. In addition, features from one or more of the above-described embodiments may be selected and combined to create alternative embodiments comprised of a combination of features which may not be explicitly described above. Features suitable for such combinations and sub-combinations would be readily apparent to persons skilled in the art upon review of the present disclosure as a whole. The subject matter described herein intends to cover and embrace all suitable changes in technology.

The scope of the claims should not be limited by the embodiments set forth in the examples, but should be given the broadest interpretation consistent with the description as a whole.

1. A controller for controlling a resonant converter network, the resonant converter network including a switching network, the switching network including a first set of switches and a second set of switches in parallel with the first set of switches, each set of switches including a first switch and a second switch, the resonant converter network further including a resonant network and an output rectifier network, the controller comprising components configured to:
receive feedback input signals;
provide output signals to operate the one set of switches based on the received feedback input signals; and
provide output signals to the other set of switches to maintain an active signal state of the first switch and to maintain an inactive signal state of the second switch.

2. A controller according to claim 1, wherein the controller is further configured to operate the switching network in a full-bridge converter mode to provide output signals to operate both sets of switches based on the received feedback input signals.

3. A controller according to claim 2, wherein the controller is further configured to provide a transition to the full-bridge converter mode, the transition including controlling one set of switches to gradually increase or decrease the duty cycle of one switch to a determined duty cycle based on the received feedback input signals.

4. A controller according to claim 2, wherein the controller is further configured to provide a transition from the full-bridge converter mode to provide output signals to operate one set of switches at a determined duty cycle based on the received feedback signals, and is configured to provide output signals to operate the other set of switches to gradually decrease or increase their duty cycles to a state which maintains their signal state.

5. The controller as claimed in claim 1, wherein the resonant converter network further includes a voltage controllable switch within the resonant network, said voltage controllable switch being operable to interrupt current in the resonant network by maintaining a high voltage across the switch.

6. A controller according to claim 5, wherein the voltage controllable switch is controlled to interrupt current in the resonant network when the state of the other set of switches are maintained.

7. A controller according to claim 2, wherein the controller is configured to operate the switching network to or from the full-bridge converter mode based on reaching a determined threshold of a control variable of the received feedback input signals.

8. A controller according to claim 7, wherein the controller further includes a hysteretic controller for switching to and from the full bridge converter mode.

9. A controller according to claim 7, wherein the threshold of the control variable varies in dependence of environmental measurements.

10. A controller according to claim 1, wherein the feedback input signals include signals based on environmental measurements.

11. A controller according to claim 1, wherein a mode of operation of the switching network is determined based on the feedback input signals.

12. A controller for controlling a resonant converter network, the resonant converter network including a switching network, the switching network including a first set of switches and a second set of switches in parallel with the first set of switches, each set of switches including a first switch and a second switch, the resonant converter network further including a resonant network and an output rectifier network, the controller comprising components configured to:
receive feedback input signals;
provide output signals to operate the one set of switches based on the received feedback input signals; and
provide output signals to the other set of switches to maintain an active signal state of the first switch and to maintain an inactive signal state of the second switch.
wherein in each set of switches output signals to the first switch are inverted with respect to the output signals to the second switch.

13. A controller for controlling a resonant converter network, the resonant converter network including a switching network, the switching network including a first set of switches and a second set of switches in parallel with the first set of switches, each set of switches including a first switch and a second switch, the resonant converter network further including a resonant network and an output rectifier network, the controller comprising components configured to:
receive feedback input signals;
provide output signals to operate the one set of switches based on the received feedback input signals; and
provide output signals to the other set of switches to maintain an active signal state of the first switch and to maintain an inactive signal state of the second switch
wherein the switching network excludes DC blocking capacitors.

14. A controller for controlling a resonant converter network, the resonant converter network including a switching network, the switching network including a first set of switches and a second set of switches in parallel with the first set of switches, each set of switches including a first switch and a second switch, the resonant converter network further including a resonant network and an output rectifier network, the controller comprising components configured to:
receive feedback input signals;
provide output signals to operate the one set of switches based on the received feedback input signals; and
provide output signals to the other set of switches to maintain an active signal state of the first switch and to maintain an inactive signal state of the second switch
wherein the resonant network includes a resonant capacitor connected so as to block DC current when the first switch is maintained at the active signal state.

15. A controller for controlling a resonant converter network, the resonant converter network including a switching network, the switching network including a first set of switches and a second set of switches in parallel with the first set of switches, each set of switches including a first switch and a second switch, the resonant converter network further including a resonant network and an output rectifier network, the controller comprising components configured to:
receive feedback input signals;
provide output signals to operate the one set of switches based on the received feedback input signals; and
provide output signals to the other set of switches to maintain an active signal state of the first switch and to maintain an inactive signal state of the second switch.
wherein at least one of the switches are metal-oxide-semiconductor field-effect transistors (MOSFET).

16. A controller for controlling a resonant converter network, the resonant converter network including a switching network, the switching network including a first set of switches and a second set of switches in parallel with the first set of switches, each set of switches including a first switch and a second switch, the resonant converter network further including a resonant network and an output rectifier network, the controller comprising components configured to:
receive feedback input signals;
provide output signals to operate the one set of switches based on the received feedback input signals; and
provide output signals to the other set of switches to maintain an active signal state of the first switch and to maintain an inactive signal state of the second switch
wherein at least one of the switches are metal-oxide-semiconductor field-effect transistors (MOSFET); and
wherein the other set of switches which are controlled to have a maintained signal state are selected between the first set of switches and the second set of switches to distribute wear and heat amongst the switches.

17. A controller as claimed in claim 1, wherein the controller is configured to operate the resonant converter network in one of many operating modes.

18. A controller according to claim 17, wherein the controller is configured to operate the resonant converter network in a half-bridge converter mode and with at least one other control mode such as phase shift control (full bridge), frequency control (full or half bridge), duty cycle control (full or half bridge), or resonant network interrupt control (full or half bridge).

19. A non-transitory computer readable medium having instructions stored thereon executable by a controller for controlling a resonant converter network, the resonant converter network including a switching network, the switching network including a first set of switches and a second set of switches in parallel with the first set of switches, each set of switches including a first switch and a second switch, the resonant converter network further including a resonant network and an output rectifier network, the instructions comprising:
instructions for receiving feedback input signals;
instructions for providing output signals to operate one set of switches based on the received feedback input signals; and
instructions for providing output signals to the other set of switches to maintain an active signal state of the first switch and to maintain an inactive signal state of the second switch.

20. A method for controlling a resonant converter network, the resonant converter network including a switching network, the switching network including a first set of switches and a second set of switches in parallel with the first set of switches, each set of switches including a first switch and a second switch, the resonant converter network further including a resonant network and an output rectifier network, the method comprising:
receiving feedback input signals;
providing output signals to operate one set of switches based on the received feedback input signals; and
providing output signals to the other set of switches to maintain an active signal state of the first switch and to maintain an inactive signal state of the second switch.
